(19) United States
(12) Patent Application Publication
(10) Pub. No.: US 2009/0087513 A1
(43) Pub. Date: Apr. 2, 2009

(54) Fiber and fatty acid composition and method of making same

(76) Inventors: Jay Satz, Dresher, PA (US); Jeffrey Brous, Horsham, PA (US); Samantha Doman, Horsham, PA (US)

Correspondence Address: KELLEY DRYE & WARREN LLP, 3050 K STREET, NW, SUITE 400, WASHINGTON, DC, 20007, US

(21) Appl. No.: 12/243,566

(22) Filed: Oct. 1, 2008

Related U.S. Application Data
(60) Provisional application No. 60/960,491, filed on Oct. 1, 2007.
(60) Provisional application No. 60/960,490, filed on Oct. 1, 2007.

(51) Int. Cl. A23L 1/29

(52) U.S. Cl. 426/2; 426/648

(57) ABSTRACT

The invention is a mixture of soluble dietary fibers in conjunction with omega three fatty acids designed to add soluble, heart healthy fibers and omega three fatty acids into a balanced diet by food manufacturers incorporating as part of the food matrix, or by end users.

### CROSS-REFERENCE TO RELATED APPLICATIONS

The present invention relates to, and is entitled to the benefit of the earlier filing date and priority of, Application No. 60/960,491 and Application No. 60/960,490, both filed on Oct. 1, 2007, which are herein incorporated by reference as if fully set forth.

### FIELD OF THE INVENTION

The present invention relates to nutritional compositions. In particular, the present invention relates to a dietary supplement composition that incorporates additional fiber and fatty acids into the user's diet.

### BACKGROUND OF THE INVENTION

The use of nutrient formulations is well documented. The known formulations, with varying degrees of success, are used as dietary supplements to promote the health of the user. Many people do not receive an adequate amount of fiber or particular fatty acids in their normal diet. What is needed in the industry is a formulation comprising dietary fiber and fatty acids, including, but not limited to, omega three fatty acids, that may be used to supplement one's diet. What is needed is a formulation that may be added to a variety of foods, either at the production stage or by the end user.

What is needed in the industry is a composition and method of making the same that increases the fiber and fatty acid content of the user.

It is an advantage of the present invention to incorporate additional fiber and omega three fatty acids into a user's diet or nutritional program.

It is another advantage of the present invention to increase daily fiber consumption and add in the healthy components omega three fatty acids.

### SUMMARY OF THE INVENTION

Responsive to the foregoing challenges, Applicant has developed a novel nutritional formulation. One embodiment of the present invention is a dietary supplement composition comprising a soluble fiber blend derived from dextrin, oats, citrus, hydrocolloids, and omega three fatty acids, wherein the dextrin may be comprised of corn dextrin, the citrus may be comprised of citrus pulp fiber, the oats may be comprised of oat fiber comprising about 22% beta-glucan, and wherein the hydrocolloids may be comprised of one or more of microcrystalline cellulose, xanthan, and konjac gums. The omega three fatty acids may provide a dose of about 150 milligrams of omega three fatty acids, and the omega three fatty acids may comprise a ratio of eicosapentaenoic acid (EPA) to docosahexaenoic acid (DHA) of about 18:12. The omega three fatty acids may be comprised of microencapsulated omega three fatty acids.

The dietary supplement composition may further comprise wheat fiber and/or plant extracts. The dextrin may comprise from about 68.10% to about 72.50% soluble corn dextrin, the oats may comprise from about 9.50% to about 11.25% soluble oat fiber, the citrus may comprise from about 7.90% to about 9.25% soluble citrus fiber, and the omega three fatty acids may comprise from about 5.90% to about 7.20% microencapsulated N−3 (EPA & DHA) fatty acids. The hydrocolloids may comprise from about 2.90% to about 4.10% of a hydrocolloid blend.

The dietary supplement composition may be lipid and/or water soluble. In one embodiment the dietary supplement composition may comprise dextrin, oat bran, citrus fiber, refined fish oil, wheat fiber, gelatin, and hydrocolloids. The refined fish oil may be comprised of one or more of anchovy oil, sardine oil, tuna oil, and menhaden oil.

An embodiment of the present invention is a method for increasing the amount of dietary fiber and omega three fatty acids in a mammal in need thereof, comprising the step of administering a dietary supplement composition comprising a soluble fiber blend derived from dextrin, oats, citrus, hydrocolloids, and omega three fatty acids.

It is to be understood that both the foregoing general description and the following detailed description are exemplary and explanatory only, and are not restrictive of the invention as claimed. The accompanying tabless, which are incorporated herein by reference, and which constitute a part of this specification, illustrate certain embodiments of the invention and, together with the detailed description, serve to explain the principles of the present invention.

### DETAILED DESCRIPTION OF THE INVENTION

An embodiment of the present invention is a mixture of soluble dietary fibers in conjunction with omega three fatty acids designed to add soluble, heart healthy fibers and omega three fatty acids into a balanced diet by food manufacturers incorporating as part of the food matrix. The product is easily formulated into several product matrices (i.e. pastries, breads, retort, powders etc.) and enhances certain organoleptic qualities (i.e. mouth-feel, texture). The composition provides a commercial product that allows a convenient solution for consumers who are not ingesting enough fiber and/or omega-3 fatty acids without having to take a supplement; it could be incorporated into various foods before sale to the user.

The composition according to an embodiment of the present invention may comprise dextrin, oat fiber, citrus fiber, hydrocolloids, and omega three fatty acids. The dextrin may be comprised of corn dextrin, or any other suitable dextrin. The composition according to an embodiment of the present invention is an easier way to add in fiber and omega three fatty acids to a user's diet, especially for those users that don't eat fish. The composition and its use are cost effective, and the composition is easily incorporated into common foodstuff and meal occasions. The composition is both heat and shelf stable, and is easily incorporated into product formulations. The composition is lipid and water dispersible, and lipid soluble.

It was unexpected that the composition according to an embodiment of the present invention provided potential use in a multitude of product applications, e.g. pastries, breads, retort, dry mix of which the blend is lipid and aqueous dispersible.

In one embodiment, the composition comprises a homogenous mixture of several soluble fibers, including, but not limited to, dextrin, including, but not limited to, corn dextrin, citrus pulp fiber, oat fiber (about 22% beta glucan), hydrocolloids, including, but not limited to, microcrystalline cellulose, xanthan and konjac gums, and microencapsulated omega-3 (n-3) fatty acids (GRAS approved and provides a dose of about 150 mg of omega three fatty acids with EPA:DPA of about 18:12).

### EXAMPLE 1

One embodiment of the present invention may comprise from about 68.10 to about 72.50% Soluble Corn Dextrin (min. 72% Soluble Fiber); from about 9.50 to about 11.25% Soluble Oat Fiber (min. 20% Beta Glucan); from about 7.90 to about 9.25% Soluble Citrus Fiber (min. 25% soluble fiber); from about 5.90 to about 7.20% Microencapsulated N−3 (EPA & DHA) Fatty Acids; and from about 2.90 to about 4.10% Hydrocolloid Blend (min. 40% soluble fiber).

### EXAMPLE 2

One embodiment of the present invention is a soluble fiber blend derived from corn, oats, citrus, hydrocolloids, and omega three fatty acids (fish derived). The composition is a white to beige powder which is free flowing, and has a very neutral to sweet aroma.

In one embodiment, the composition may comprise dextrin, oat bran, citrus fiber, refined fish oil, including, but not limited to, anchovy oil, sardine oil, tuna oil, menhaden oil, wheat fiber, plant extracts, including, but not limited to, plant sterols and plant stanols, gelatin, including, but not limited to, gelatin derived from fish, including, but not limited to, tilapia, sardine, and anchovy, canola oil, natural flavor, tocopherols, sunflower oil, citric acid, and hydrocolloids. The hydrocolloids may be, but are not limited to, microcrystalline cellulose, xanthan gum, Konjac flour and any other food-grade use hydrocolloids. The citrus fiber may also be labeled as citrus flour or dried orange pulp as USDA products require one of these two names.

### EXAMPLE 3

An analysis of the nutritional data of an embodiment of the present invention is shown in Tables 1 and 2.

TABLE 1
NUTRITIONAL DATA: Basic Components (BASED ON 100 g)

| Calories | 198.32 | |
|---|---|---|
| Calories from Fat | 46.36 | |
| Protein | 5.43 | |
| Carbohydrates | 84.41 | g |
| Dietary Fiber | 72.03 | g |
| Soluble Fiber | 56.06 | g |
| Insoluble Fiber | 15.95 | g |
| Sugar | 0.94 | g |
| Fat | 5.15 | g |
| Saturated Fatty Acids | 1.32 | g |
| Monounsaturated Fatty Acids | 1.09 | g |
| Polyunsaturated Fatty Acids | 1.85 | g |
| Trans Fatty Acids | 0.07 | g |
| Omega 3 Fatty Acids | 1.29 | g |
| Cholesterol | 21.98 | mg |
| Water | 4.44 | g |
| Ash | 1.20 | g |

TABLE 2
NUTRITIONAL DATA: Vitamins
& Minerals (BASED ON 100 g)

| | | |
|---|---|---|
| Vitamin A | 0.06 | IU |
| Vitamin C | 64.65 | mg |
| Thiamin | 0.05 | mg |
| Riboflavin | 0.02 | mg |
| Pyridoxine | 0.02 | mg |
| Folate | 1.38 | mcg |
| Calcium | 31.08 | mg |
| Iron | 1.15 | mg |
| Magnesium | 21.53 | mg |
| Potassium | 68.62 | mg |
| Sodium | 134.31 | mg |
| Zinc | 0.64 | mg |

### EXAMPLE 4

An analysis of the nutritional data from a single serving according to an embodiment of the present invention is shown in Table 3.

TABLE 3
NUTRITIONAL DATA: Based on a single serving, per product

| Serving Size | 3.00 | g |
|---|---|---|
| Calories | 5.95 | |
| Calories from Fat | 1.39 | |
| Total Fat | 0.15 | g |
| Saturated Fat | 0.04 | g |
| Omega 3 Fatty Acids | 0.04 | g |
| Trans Fat | 0.00 | g |
| Cholesterol | 0.66 | mg |
| Sodium | 4.03 | mg |
| Total Carbohydrates | 2.53 | g |
| Dietary Fiber | 2.16 | g |
| Soluble Fiber | 1.68 | g |
| Insoluble Fiber | 0.48 | g |
| Sugars | 0.03 | g |
| Protein | 0.16 | g |
| Water | 0.13 | g |
| Ash | 0.04 | g |
| Vitamin A | 0.00* | |
| Vitamin C | 1.94 | mg |
| Calcium | 0.93 | mg |
| Iron | 0.03 | mg |

### EXAMPLE 4

One embodiment of the present invention is both oil and lipid soluble. It may also act as a system stabilizer in conjunction with other fibers, starches or hydrocolloids. One embodiment has minimal to no flavor impact, and may be shelf stable in an airtight container or lined bag. In one embodiment, if room is needed, protein levels can be decreased by about 1 gram or more, but no more than about 3 grams. This may provide an economic advantage during production.

### EXAMPLE 5

10 grams of the composition according to an embodiment of the present invention was combined with 90 grams of distilled water and whisked vigorously. The resulting solution had a slightly sweet aroma and taste with no off notes, including, but not limited to, rancidity, chemical etc.

Numerous characteristics and advantages have been set forth in the foregoing description, together with details of composition and function. The novel features are pointed out in the appended claims. The disclosure, however, is illustrative only, and changes, may be made in detail, especially in matters of ranges of components and nutritional value, within the principle of the invention, to the full extent indicated by the broad general meaning of the terms in which the appended claims are expressed.

What is claimed is:

1. A dietary supplement composition comprising a soluble fiber blend derived from dextrin, oats, citrus, hydrocolloids, and omega three fatty acids.

2. The dietary supplement composition according to claim 1, wherein the dextrin is comprised of corn dextrin.

3. The dietary supplement composition according to claim 1, wherein the citrus is comprised of citrus pulp fiber.

4. The dietary supplement composition according to claim 1, wherein the oats are comprised of oat fiber comprising about 22% beta-glucan.

5. The dietary supplement composition according to claim 1, wherein the hydrocolloids are comprised of one or more of microcrystalline cellulose, xanthan, and konjac gums.

6. The dietary supplement composition according to claim 1, wherein the omega three fatty acids provide a dose of about 150 milligrams of omega three fatty acids.

7. The dietary supplement composition according to claim 1, wherein the omega three fatty acids comprise a ratio of eicosapentaenoic acid (EPA) to docosahexaenoic acid (DHA) of about 18:12.

8. The dietary supplement composition according to claim 1, wherein the omega three fatty acids are comprised of microencapsulated omega three fatty acids.

9. The dietary supplement composition according to claim 1, further comprising wheat fiber.

10. The dietary supplement composition according to claim 1, further comprising plant extracts.

11. The dietary supplement composition according to claim 1, wherein the dextrin comprises from about 68.10% to about 72.50% soluble corn dextrin.

12. The dietary supplement composition according to claim 1, wherein the oats comprise from about 9.50% to about 11.25% soluble oat fiber.

13. The dietary supplement composition according to claim 1, wherein the citrus comprises from about 7.90% to about 9.25% soluble citrus fiber.

14. The dietary supplement composition according to claim 1, wherein the omega three fatty acids comprise from about 5.90% to about 7.20% microencapsulated N-3 (EPA & DHA) Fatty Acids.

15. The dietary supplement composition according to claim 1, wherein the hydrocolloids comprise from about 2.90% to about 4.10% of a hydrocolloid blend.

16. The dietary supplement composition according to claim 1, wherein the composition is lipid soluble.

17. The dietary supplement composition according to claim 1, wherein the composition is water soluble.

18. A dietary supplement composition comprising dextrin, oat bran, citrus fiber, refined fish oil, wheat fiber, gelatin, and hydrocolloids.

19. The dietary supplement composition according to claim 18, wherein the refined fish oil is comprised of one or more of anchovy oil, sardine oil, tuna oil, and menhaden oil.

20. A method for increasing the amount of dietary fiber and omega three fatty acids in a mammal in need thereof, comprising the step of administering a dietary supplement composition comprising a soluble fiber blend derived from dextrin, oats, citrus, hydrocolloids, and omega three fatty acids.
